(19) United States
(12) Patent Application Publication
(10) Pub. No.: US 2023/0144220 A1
(43) Pub. Date: May 11, 2023

(54) CHARGING MEMBER AND ELECTROPHOTOGRAPHIC IMAGING APPARATUSES EMPLOYING THE SAME

(71) Applicant: Hewlett-Packard Development Company, L.P., Spring, TX (US)

(72) Inventors: NORIHIRO HARADA, Suwon (KR); YOUNGPHIL JI, Seongnam Si (KR); JINMO HONG, Seongnam Si (KR)

(21) Appl. No.: 17/789,330

(22) PCT Filed: Jul. 27, 2020
(86) PCT No.: PCT/US2020/043664

§ 371 Date: Jun. 27, 2022

(30) Foreign Application Priority Data
Jan. 14, 2020 (KR) 10-2020-0005029

(51) Int. Cl. G03G 15/02; C09D 7/65; C09D 7/40; C09D 175/04

(52) U.S. Cl. CPC G03G 15/0233; C09D 7/65; C09D 7/69; C09D 175/04

(57) ABSTRACT

An example charging member has a surface layer including a binder resin, first particles, and second particles, the first and second particles being dispersed in the binder resin, the first particles include acrylic resin particles having an average particle diameter of about 16 μm to about 35 μm, and the second particles include spherical silica particles having an average particle diameter of about 3 μm to about 10 μm. The content of the first particles is in a range of about 5 parts by weight to about 20 parts by weight and when a mass of the first particles is M1 and a mass of the second particles M2, the condition of 0.2≤M1/(M1+M2)≤0.8 is satisfied.

### BACKGROUND

An electrophotographic imaging apparatus includes a photoconductor and a charging roller, a developing roller, or a transfer roller, which are provided around the photoconductor. The charging roller charges a surface of the photoconductor to a predetermined voltage. An electrostatic latent image corresponding to print data is formed on the charged surface of the photoconductor with light emitted from an exposure unit. The developing roller supplies a developer to the photoconductor to develop the electrostatic latent image into a developer image. The developer image is transferred by the transfer roller onto an image receiving member passing between the photoconductor and the transfer roller.

### BRIEF DESCRIPTION OF DRAWINGS

Various examples will be described below with reference to the following figures.

FIG. 1 is a cross-sectional view schematically illustrating a charging roller according to an example.

FIG. 2 is a cross-sectional view schematically illustrating an enlarged surface layer of a charging roller according to an example.

FIG. 3 is a cross-sectional view schematically illustrating an electrophotographic imaging apparatus and an electrophotographic cartridge including a charging roller according to an example.

### DETAILED DESCRIPTION OF EXAMPLES

Hereinafter, various examples will be described with reference to the accompanying drawings. In the following description, components having substantially the same functional configuration will be omitted by repeating the same reference numerals.

When an electrostatic latent image is formed, a contact charging method may be used in which a charging roller contacts a photoconductor to charge a surface of the photoconductor as an image carrier. In an example, an electroconductive roller may be used as the charging roller. In this example method, a surface of the photoconductor is charged by applying a voltage to a conductive support (e.g., a shaft) using the charging roller to perform a microdischarge in the vicinity of a contact nip between the charging roller and the photoconductor. The charging roller may have a structure in which a conductive elastic body layer is formed on the conductive support (e.g., a shaft) and a resistance layer is formed on the conductive elastic body layer.

Through use in a contact charging method, a charging member (e.g., charging roller) may electrically deteriorate due to surface wear. In that case, a charging performance may also deteriorate with the passage of time. When charging performance deteriorates, a charging ability of the charging member may be reduced, and image defects such as background (BG) defects and micro-jitter (fine horizontal stripes) defects may occur.

Hereinafter, an example charging member and an electrophotographic imaging apparatus and an electrophotographic cartridge including the charging member will be described. A description will be made based on a charging roller as an example. However, the following description may be equally applied to a charging member having a shape other than a roller, such as a corona charger or a charging brush.

A charging member according to an example includes a conductive support, a conductive elastic body layer, and a surface layer as an outermost layer.

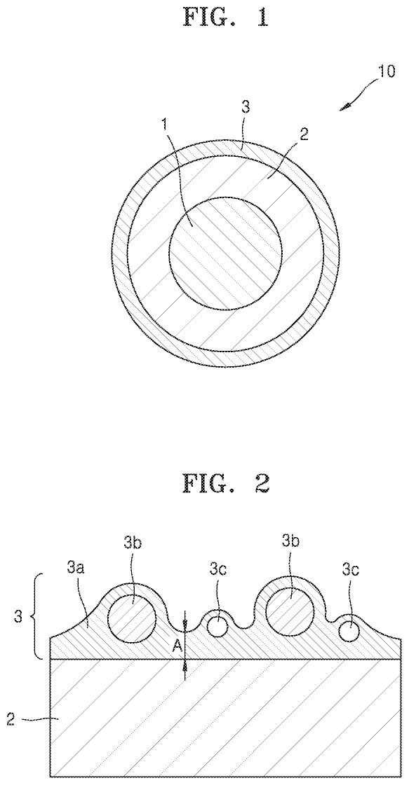

FIG. 1 is a schematic cross-sectional view of a charging roller according to an example.

Referring to FIG. 1, in a charging roller 10, a conductive elastic body layer 2 and a surface layer 3 are provided on an outer circumference surface of a conductive support 1 having a shaft shape. The conductive elastic body layer 2 and the surface layer 3 may be provided in this order from an inner side in the diameter direction of the charging roller 10 toward the outer side in the diameter direction of the charging roller 10. In an example, the conductive elastic body layer 2 and the surface layer 3 may be integrally laminated on the outer circumference surface of the conductive support 1. An intermediate layer (not shown) such as a resistance adjustment layer for increasing voltage resistance (i.e., leak resistance) may be formed between the conductive elastic body layer 2 and the surface layer 3.

In an example imaging apparatus, the charging roller 10 shown in FIG. 1 is provided as a charging means for charging a body to be charged, and may function as a charging means for charging the surface of the photoconductor as an image carrier.

### Conductive Support 1

In an example, the conductive support 1 includes a metal having electrical conductivity. For example, a metallic hollow body (a pipe shape) or a metallic solid body (a rod shape) including iron, copper, aluminum, nickel, or stainless steel may be used. An outer circumference surface of the conductive support 1 may be plated for reducing or preventing rust or to provide scratch resistance. The outer circumference surface of the conductive support 1 may be plated to a degree that does not impair electrical conductivity. Further, the outer circumference surface of the conductive support 1 may be coated with an adhesive, a primer, or the like in order to increase adhesion to the conductive elastic body layer 2, if necessary. In this case, in order to provide electrical conductivity, this adhesive, primer, etc. in itself may be made electrically conductive as needed.

The conductive support 1 may have a cylindrical shape having a diameter of about 4 mm to about 20 mm, for example, about 5 mm to about 10 mm and having a length of about 200 mm to about 400 mm, for example, about 250 mm to about 360 mm.

### Conductive Elastic Body Layer 2

In an example, the conductive elastic body layer 2 may have elasticity suitable for securing uniform adhesion to the photoconductor. For example, the conductive elastic body layer 2 may be formed using a binder resin selected from natural rubbers, synthetic rubbers such as ethylene-propylene-diene monomer rubber (EPDM), styrene-butadiene rubber (SBR), a silicone rubber, a polyurethane-based elastomer, epichlorohydrin (ECO) rubber, isoprene rubber (IR), butadiene rubber (BR), acrylonitrile-butadiene rubber (NBR), hydrogenated NBR (H-NBR), and chloroprene rubber (CR), and synthetic resins such as an amide resin, a urethane resin, and a silicone resin. These may be used alone or in combination of two or more. In an example, as epichlorohydrin (ECO) rubber containing ethylene oxide (EO) residue in its molecule has ionic conductivity and is relatively low and stable in electrical resistance, the epichlorohydrin (ECO) rubber may be used as a binder resin. The conductive elastic body layer 2 may contain epichlorohydrin rubber, and, may contain epichlorohydrin rubber as a main component. In an example, the conductive elastic body layer 2 may contain epichlorohydrin rubber in an amount of 50.0 wt % or more or 80.0 wt % or more.

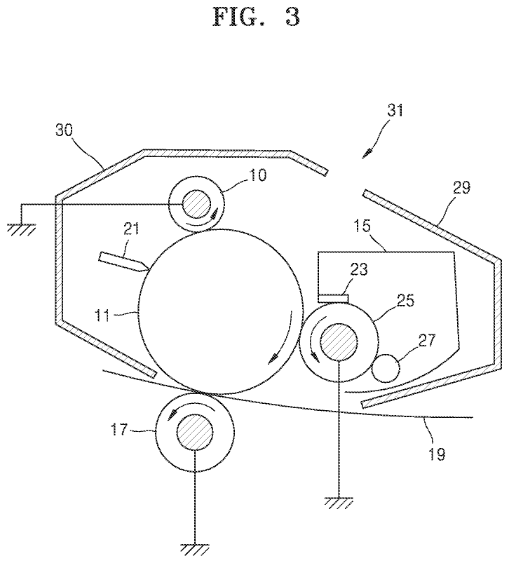

The charging roller 10 may be in contact with a photoconductor (e.g., electrophotographic photoconductor drum 11 of FIG. 3) when used in a contact developing method, and may be spaced apart from the photoconductor when used in a non-contact developing method.

In the case of a one-component contact developing method, the conductive elastic body layer 2 may be adjusted to have a hardness of 25 to 45 as measured by an Asker-A TYPE durometer, and in the case of an one-component non-contact developing method, the conductive elastic body layer 2 may be adjusted to have a hardness of 40 to 65 as measured by an Asker-A TYPE durometer. In other examples, the hardness may be determined according to a printer speed, lifetime, cost, etc., and the hardness may vary depending on the developing method.

The conductive elastic body layer 2 may have a thickness of about 0.5 mm to about 8.0 mm, for example, about 1.25 mm to about 3.00 mm. Within the thickness range, the charging roller 10 exhibits elasticity and recovery against deformation, and a stress imparted on toner may be reduced. In the case of the one-component non-contact developing method, the thickness of the conductive elastic body layer 2 may be about 0.5 mm to 2.0 mm, and in the case of the one-component contact developing method, the thickness of the conductive elastic body layer 2 may be about 1.5 mm to 8.0 mm.

The conductive elastic body layer 2 may include a conductive agent. The conductive agent may include an ion-conducting agent and an electron-conducting agent. The conductive elastic body layer 2 may include an ion-conducting agent in consideration of resistance stability, Since the ion-conducting agent may be uniformly dispersed in a polymer elastic body to make the electrical resistance of the conductive elastic body layer 2 uniform, uniform charging may be obtained even when the charging roller 10 is charged using a DC voltage.

The ion-conducting agent may be selected depending on the purpose. Examples of the ion-conducting agent may include alkali metal salts, alkaline earth metal salts, perchlorates of quaternary ammonium, chlorates, hydrochlorides, bromates, iodates, hydroborates, sulfates, trifluoromethyl sulfates, sulfonates, and trifluoromethane sulfonates. These may be used alone or in combination of two or more. The alkali metal salts may be selected depending on the purpose. Examples thereof may include lithium salts, sodium salts, and potassium salts. These may be used alone or in combination of two or more. Examples of the lithium salts may include Li[B(C₁₄H₁₀O₃)₂], Li(CF₃SO₂)₂N, Li(C₂F₅SO₂)₂N, LiClO₄, LiBF₄, LiPF₆, LiCF₃SO₃, LiAsF₆, and LiC₄F₉SO₃.

Examples of the quaternary ammonium salts may include cationic surfactants such as lauryltrimethylammonium chloride, stearyltrimethylammonium chloride, octadecyltrimethylammonium chloride, didecyldimethylammonium chloride, hexadecyltrimethylammonium chloride, trioctylpropylammonium bromide, tetrabutylammonium chloride, and behenyltrimethylammonium chloride, amphoteric surfactants such as lauryl betaine, stearyl betatine, dimethyl lauryl betaine, and tetraethyl ammonium perchlorate, tetrabutyl ammonium perchlorate, and trimethyl octadecyl ammonium perchlorate, or the like.

The amount of the ion-conducting agent used may be in a range of about 0.01 parts by weight to about 10 parts by weight, or in a range of about 0.5 parts by weight to about 5 parts by weight, based on 100 parts by weight of the binder resin. These ion-conducting agents may be used alone or in combination of two or more.

The electron-conducting agent may be used in combination with the ion-conducting agent.

As the electron-conducting agent, for example, carbon black may be used. Examples of the carbon black may include conductive carbon black such as oxidized carbon black for use in ink to improve dispersibility, ketjen black, and acetylene black, carbon black for rubber such as SAF, ISAF, IAAF, FEF, GPF, SRF, FT, and MT grades, and pyrolytic carbon black, natural graphite, and artificial graphite. As the electron-conducting agent, for example, metal oxides such as doped tin oxide, indium tin oxide (ITO), tin oxide, titanium oxide, zinc oxide, metals such as nickel, copper, silver, and germanium, electrically conductive polymers such as polyaniline, polypyrrole, and polyacetylene, and conductive whiskers such as carbon whisker, graphite whisker, titanium carbide whisker, conductive potassium titanate whisker, conductive barium titanate whisker, conductive titanium oxide whisker, and conductive zinc oxide whisker may be used. To reduce a difference in electrical resistance and to reduce a hardness, a small amount of the electron-conducting agent may be used. The amount of the electron-conducting agent used may be in a range of about 30 parts by weight or less, for example, in a range of about 10 parts by weight or less, based on 100 parts by weight of the binder resin.

The resistance value of the conductive elastic body layer 2 by the combination of the conducting agent may be adjusted to about 10³Ω to about 10¹⁰Ω, and may be adjusted to about 10⁴Ω to about 10⁸Ω. When the resistance value of the conductive elastic body layer 2 is less than 10³Ω, the charges on the photoconductor may leak and thus an imbalance in electrical resistance may occur to cause spots on an image, or hardness may increase to make uniform contact with the photoconductor difficult, and image stains may occur. When the resistance value of the conductive elastic body layer 2 is more than 10¹⁰Ω, background (B/G) image defects may occur.

The conductive elastic body layer 2 may contain additives such as a filler, a foaming agent, a crosslinking agent, a crosslinking accelerator, a lubricant, and an auxiliary agent, as needed. The crosslinking agent may include sulfur. The crosslinking accelerator may include tetramethylthiuram disulfide (CZ). The lubricant may include stearic acid. The auxiliary agent may include zinc oxide (ZnO).

### Surface Layer 3

The surface layer 3 may include a binder resin, and first particles and second particles dispersed in the binder resin.

FIG. 2 is a schematic cross-sectional view illustrating an enlarged surface layer of a charging roller according to an example.

Referring to FIG. 2, the surface layer 3 may contain a urethane resin as a binder resin 3a, which forms a matrix material, and may contain acrylic resin particles 3b having an average particle diameter of about 16 μm to about 35 μm and spherical silica particles having an average particle diameter of about 3 μm to about 10 μm.

The binder resin 3a may be selected to avoid contamination of the photoconductor, which is a body to be charged. Examples of the binder resin may include a fluorine resin, a polyimide resin, an acrylic resin, a nylon resin, a urethane resin, a silicone resin, a butyral resin, styrene-ethylene/butylene-olefin copolymer (SEBC), and olefin-ethylene/butylene-olefin copolymer (CEBC). These may be used alone or in combination of two or more. In an example, the binder resin may be selected from a fluorine resin, an acrylic resin, a nylon resin, a urethane resin, and a silicone resin. The binder resin may be selected from a nylon resin and a urethane resin. The binder resin may contain a urethane resin.

When the binder resin contains urethane resin, the urethane resin may be formed by a chain extension reaction of a polyol mixture of polyester polyol and polyether polyol with a polyisocyanate. Since polyester polyol and polyether polyol are used together, their respective advantages may be used together.

The urethane resin formed by the chain extension reaction of a polyester polyol with a polyisocyanate has excellent wear resistance at relatively low hardness. However, since the urethane resin obtained by using a polyester polyol may deteriorate at low temperature, when the urethane resin is used for a long period of time under low-temperature environments, electrical resistance may vary, and a background (B/G) image may occur. Further, since an ester-based urethane may be vulnerable to hydrolysis, when the ester-based urethane is used under high-temperature and high-humidity environments, its properties may change.

The urethane resin formed by the chain extension reaction of a polyether polyol with a polyisocyanate has low-temperature flexibility, has relatively low electrical resistance, and thus has stability. However, a polyester polyol and a polyether polyol have poor compatibility and may thus cause separation or curing difficulties. When a polyether polyol having an ethylene oxide (EO) content of about 60 wt % to about 90 wt % is used, compatibility with a polyester polyol may be addressed. The polyether polyol having an ethylene oxide (EO) content of about 60 wt % to about 90 wt % may have good compatibility with a polyester polyol. In addition, the surface layer 3 produced using this urethane resin may have low-temperature flexibility, relatively low electrical resistance, physical stability, and resistance stability at low hardness.

The surface layer 3 may include a urethane resin formed by a chain extension reaction of a polyol mixture of a polyester polyol and a polyether polyol having an ethylene oxide (EO) content of about 60 wt % to about 90 wt % with a polyisocyanate. The content ratio of a polyester polyol and a polyether polyol may be adjusted in a range of 8:2 to 2:8. When the content ratio of any one of the polyester polyol and polyether polyol is too low, improvement effects may be reduced.

As the polyester polyol, a polycaprolactam-based polyol, an adipic acid-based polyol, or the like may be used. The polyester polyol may be obtained by an esterification reaction between a compound having two or more hydroxyl groups and a polybasic acid, or may be obtained by a ring-opening addition reaction of cyclic esters such as ε-caprolactone, β-butyrolactone, γ-butyrolactone, γ-valerolactone, and δ-valerolactone using a compound having two or more hydroxyl groups as an initiator. Although polylactone-based polyols may be distinguished from polyester polyols, here, they are considered as a kind of the polyester polyols.

Examples of the aforementioned compound having two or more hydroxyl groups may include glycol compounds such as ethylene glycol, propylene glycol, 1,3-propanediol, 1,4-butanediol, 1,5-pentanedial, 1,6-hexanediol, diethylene glycol, triethylene glycol, tetraethylene glycol, dipropylene glycol, tripropylene glycol, 1,4-cyclohexanedimethanol, glycol compounds having a branched structure such as 2-methyl-1,5-pentane diol, 3-methyl-1,5-pentane 1,2-butanediol, 1,3-butanediol, 2-butyl-2-ethyl-1,3-propanediol, 1,2-propane diol, 2-methyl-1,3-propanediol, neopentyl glycol, 2-isopropyl-1,4-butanediol, 2,4-dimethyl-1,5-pentane diol, 2,4-di ethyl-1,5-pentane diol, 2-ethyl-1,3-hexanediol, 2-ethyl-1,6-hexanediol, 3,5-pentanedial, and 2-methyl-1,8-octane diol, and trimethylol propane, trimethylol ethane, pentaerythritol, and sorbitol. These compounds may be used alone or in combination of two or more.

Among ester-based polyols, an ester-based polyol having a liquid phase at room temperature may be easy to handle, may be difficult to aggregate in a coating solution, and may not generate spots on an image, and may be frequently used. Further, ester-based polyols having three or more hydroxyl groups may have a small amount of permanent deformation and good stability.

Examples of the aforementioned polybasic acid may include adipic acid, succinic acid, azeraic acid, sebacic acid, dodecanedicarboxylic acid, maleic anhydride, fumaric acid, 1,3-cyclopentanedicarboxylic acid, 1,4-cyclohexanedicarboxylic acid, and anhydrides thereof. These polybasic acids may be used alone or in combination of two or more.

As the polyether polyol having an ethylene oxide (EO) content of about 60 wt % to about 90 wt %, a bifunctional glycol or a trifunctional or more polyether polyol such as an ethylene oxide-polypropylene oxide copolymer may be used. In an example, the ethylene oxide-polypropylene oxide copolymer may be a random copolymer because hardness of the urethane resin may become low due to low crystallinity. The polyether polyol having an ethylene oxide (EO) content of about 60 wt % to about 90 wt % may be a polyether polyol produced by a random addition and/or block addition of alkylene oxides of 2 to 6 carbon atoms to the aforementioned compound having two or more hydroxyl groups. Examples of the polyether polyol may include polyoxyethylene polyoxypropylene polyol and polyoxyethylene polyoxytetramethylene polyol. For example, a trifunctional or more polyoxyethylene polyoxypropylene polyol having an ethylene oxide residue at its molecular end obtained by random addition polymerization of ethylene oxide and propylene oxide may be used. A trifunctional or more polyoxyethylene polyoxypropylene polyol may be advantageous in terms of suppressing of image defect occurrence in low-temperature and low-humidity environments, as compared with a difunctional or less polyoxyethylene polyoxypropylene polyol.

As the polyisocyanate which undergoes chain-extension with the polyol mixture including a polyester polyol and a polyether polyol having an ethylene oxide (EO) content of about 60 wt % to about 90 wt %, toluene diisocyanate (TDI), diphenylmethane diisocyanate (MDI), isophorone diisocyanate (IPDI), hydrogenated diphenylmethane diisocyanate, hydrogenated toluene diisocyanate, or hexamethylene Diisocyanate (HDI) may be used. Further, blocked polyisocyanates obtained by reacting HDI and a blocking agent has storage stability because reactive isocyanate group is blocked to inhibit a reaction at room temperature. As the blocking agent, for example, methyl ethyl ketone oxime having good storage stability and productivity and capable of adjusting dissociation temperature in a range of about 120° C. to about 160° C. may be used. When the blocking agent is dissociated by heating, an isocyanate group is regenerated, and thus the blocked polyisocyanate may react with a polyol.

The amount of polyisocyanate added may be adjusted such that the molar ratio ([NCO]/[OH]) of isocyanate (NCO) groups of polyisocyanate to total hydroxyl (OH) groups of the polyol mixture is in a range of about 12 to about 25. Polyether polyols are likely to have a lower reactivity than that of polyester polyols, and unreacted products may be left when the molar ratio is less than 12, and low-temperature flexibility may deteriorate when the molar ratio is more than 25.

When a urethane resin is used as the binder resin of the surface layer 3, the surface layer 3 may contain a small amount of other resin components for the purpose of modifying the surface layer 3. As the other resin components, a silicone graft polymer, silicone oil, an acrylic resin, or a fluorine resin may be used for improving the stain resistance of the surface.

The surface layer 3 may include other additives such as a conducting agent, a leveling agent, a filler, an antifoaming agent, a surface modifier, a dispersant, and a charge control agent. In this case, as the conducting agent, an ion-conducting agent and/or an electron-conducting agent may used.

As the ion-conducting agent that may be used for the surface layer, there are alkali metal salts, alkaline earth metal salts, and quaternary ammonium salts, which may be used for the aforementioned conductive elastic body layer 2. For example, ionic liquid (3M™ Ionic Liquid Antistat FC-5000) represented by the chemical structure of (n-Bu)₃MeN⁺⁻N(SO₂CF₃) may be used as the ion-conducting agent because it has thermal stability and may thus be easily dispersed in the urethane resin. The amount of the ion-conducting agent combined may be in a range of about 0.01 parts by weight to about 10 parts by weight or in a range of about 0.5 parts by weight to about 5 parts by weight, based on 100 parts by weight of the urethane resin. As the electron-conducting agent that may be used for the surface layer 3, the aforementioned electron-conducting agent that may be used for the conductive elastic body layer 2 may be used. For example, oxidized carbon black having good dispersibility in the surface layer 3 may be used. Because the electron-conducting agent may have a small variation in electrical resistance, the amount of the electron-conducting agent combined may be in a range of about 0.5 parts by weight to about 10 parts by weight, based on 100 parts by weight of the urethane resin.

To charge the photoconductor stably, the surface layer 3 may contain particles forming unevenness on the surface thereof (i.e., particles for forming roughness). The particles for forming roughness may include resin particles or inorganic particles. Examples of the resin particles may include acrylic resin particles, styrene resin particles, polyamide resin particles, silicone resin particles, vinyl chloride resin particles, vinylidene chloride resin particles, acrylonitrile resin particles, fluorine resin particles, phenol resin particles, polyester resin particles, melamine resin particles, urethane resin particles, olefin resin particles, and epoxy resin particles. The inorganic particles may include silica particles, alumina particles, and the like.

In an example, when the surface layer 3 contains acrylic resin particles 3b having an average particle diameter of about 16 μm to about 35 μm as first particles and spherical silica particles 3c having an average particle diameter of about 3 μm to about 10 μm as second particles based on conditions that will be described below, the wear resistance and resistance to electrical deterioration of the charging roller 10 may increase, and charging non-uniformity may be effectively suppressed, so that the charging performance of the charging roller 10 may be sufficiently maintained even when the charging roller 10 is used for a longer period of time. The average particle diameter of the first particles may be in a range of about 19 μm to about 28 μm, for example, about 20 μm to about 27 μm. Accordingly, even when an example charging roller 10 is used in a contact charging manner, the ability to uniformly charge the photoconductor may be maintained for a longer period of time. Therefore, since the charging roller 10 may maintain the charging performance and charging uniformity even when the charging roller 10 is used for a longer time in the electrophotographic imaging apparatus, it is possible to stably obtain a high-quality image in which image defects such as background (BG) and micro-jitter are suppressed. Moreover, the charging roller 10 may maintain stable charging characteristics for a longer time even when a DC voltage is applied, high-quality output images may be obtained, and the problem of BG in low-temperature and low-humidity environments may be reduced or prevented. The average particle diameter of acrylic particles and silica particles may be measured by a particle size distribution measuring device (manufacturer: Beckman Coulter, trade name: Multisizer 3).

The content of the first particles is in a range of about 5 parts by weight to about 20 parts by weight, for example, about 5 parts by weight to about 15 parts by weight, based on 100 parts by weight of the binder resin. The content (i.e., mass) of the first and second particles are adjusted to satisfy the condition of 0.2≤M1/(M1+M2)≤0.8, for example, 0.25≤M1/(M1+M2)≤0.77 in which the mass of the first particles is M1 and the mass of the second particles is M2. When the contents of the first and second particles are adjusted as described above, charging performance tends to be satisfied, and when a coating liquid for forming the surface layer 3 is prepared, the sedimentation of the particles may be controlled, and the stability of the coating liquid tends to be difficult to deteriorate.

In order for the charging roller 10 to exhibit various advantages described above, the coefficient (CV value) of variation of particle size distribution of the first particles, which is calculated by Equation (1) below, may be adjusted to be in a range of about 1% to about 15%, for example, about 5% to about 15%, about 8% to about 13%, about 9% to about 12%, or about 10% to about 12%.

CV value=(standard deviation/average particle diameter)×100(%) Equation (1)

Examples of the acrylic resin particles 3b as the first particles may include polymethyl methacrylate (PMMA) particles and/or polymethyl acrylate (PMAA) particles. In the case of monodispersed acrylic particles, for example, monodispersed PMMA particles in which the average particle diameter of the first particles is within the above range and 95% or more of the first particles is included within the range of ±2 μm of the average particle diameter of the first particles, unevenness may be formed on the surface of the surface layer 3, and discharge points may be secured, so that charging characteristics are good. The reason for this may be that appropriate voids are formed in the nip of the contact portion of the photoconductor and the charging roller 10, thereby improving charging performance.

The spherical silica particles may be unaggregated silica particles, and may include spherical silica particles, roughly spherical silica particles, and elliptical silica particles. Silica particles may exist as aggregate particles in which small particles are aggregated, and such aggregate particles are irregular-shaped particles, not spherical silica particles. Since the aggregate silica particles are difficult to stably provide an uneven shape to the surface layer 3, and the aggregation thereof is partially broken by dispersion by a bead mill or the like, the aggregate silica particles are not suitable as particles for imparting uniform uneven surface shape to the surface layer 3. In order for the charging roller 10 to exhibit various technical advantages described above, the specific surface area of the spherical silica particles 3c may be adjusted in a range of about 3 m²/g to about 50 m²/g, for example, about 10 m²/g to about 50 m²/g, about 20 m²/g to about 50 m²/g, or about 30 m²/g to 50 m²/g so as to improve charging ability and charging uniformity. The specific surface area of the silica particles may be measured by a specific surface area/pore size distribution measurement instrument (manufacturer: Microtrac BEL, trade name: BELSORP-miniX). In the case where the silica particles have the same particle diameter, as the specific surface area of the silica particles increases, the silica particles are closer to porous particles. Porous silica particles may be insufficient in charging ability and charging uniformity. A reason that porous silica particles are insufficient in charging ability to a photoconductor may be because they have a substantially large number of silanol groups on the surface thereof. Porous silica particles may have a specific surface area of about 300 m²/g to about 800 m²/g.

When using the charging roller 10 having the surface layer 3 satisfying the above-described conditions, stable charging characteristics may be maintained for a longer period of time even when a DC voltage is applied, and high-quality output images may be obtained. A mechanism by which such an effect is exhibited may be presumed as follows. In order to maintain good charging characteristics over a longer period of time, particles are generally added to the surface layer 3, which is the outermost layer of a charging member. However, when a voltage is applied to such a charging member, an electric field is concentrated on the convex portions formed by the particles. As a result, discharge tends to be generated by the convex portions, and the quality of the output image tends to deteriorate. In an example, since discharge from the convex portions may be weakened by making the surface layer 3 satisfy the above-described conditions, it is presumed that non-uniformity of the electric field on the surface of the conductive resin layer, i.e., the surface layer 3 is weakened. Thus, it is presumed that uniform discharge may occur from the entire surface of the conductive resin layer, and the quality of an output image may be improved. Accordingly, the charging roller 10 may maintain the ability to uniformly charge the photoconductor over a longer period even when it is used in a contact charging manner. Therefore, since the charging roller 10 can maintain charging performance and charging uniformity even when the charging roller 10 is used for a longer time in an electrophotographic imaging apparatus, it is possible to stably obtain high quality images in which image defects such as background (BG) and micro-jitter are suppressed. Moreover, the charging roller 10 may maintain stable charging characteristics over a longer period of time even when a DC voltage is applied, high-quality output images may be obtained, and a problem of BG under low-temperature and low-moisture environments may be reduced or prevented.

The thickness of the surface layer 3 may be about 1 μm to about 20 μm. When the thickness thereof is 1 μm or greater, the resin particles and/or the inorganic particles to be added may be maintained without being detached over a longer period of time. When the thickness thereof is 20 μm or less, the charging performance may be maintained. In this regard, the thickness of the surface layer 3 may be in a range of about 1 μm to about 15 μm, about 1 μm to about 10 μm, about 1 μm to about 8 μm, about 1 μm to about 7 μm, or about 1 μm to about 5 μm. Here, the thickness of the surface layer 3 may be a layer thickness (the ‘A’ portion of FIG. 2) of the portion formed by the binder resin alone. For example, the thickness of the conductive resin layer is a thickness of the binder resin at the intermediate point between neighboring particles. When the thickness of the surface layer 3 is less than 1 μm, wear resistance is liable to decrease due to long-term use, and performance of preventing a phenomenon in which unreacted crosslinking materials are bled out from the conductive elastic body layer 2 to the surface layer 3 deteriorates. When the thickness of the surface layer 3 is greater than 20 μm, since the surface layer 3 may become hard and inflexible, its durability may be deteriorated and cracks may be generated by its use, and the toner used may be damaged, so that the toner may stick to the photoconductor or the cleaning blade, resulting in image defects. The thickness of the surface layer 3 may be measured by cutting out the charging roller cross section with a sharp blade and observing the piece with an optical microscope or an electron microscope.

In an example, a DC voltage is applied to the charging roller 10. For example, the bias voltage applied during image output may be about −1500 V to about −1000 V. This may assist in controlling the image density and various conditions while maintaining the charging performance under various environments. When the bias voltage is higher than −1000 V, it becomes difficult to optimize the developing conditions for image formation. In contrast, when the bias voltage is lower than −1500 V, over-discharge tends to occur in the particle portions of the conductive resin layer, and white spot-like image defects tend to occur after image formation.

### Method of Manufacturing Charging Member

The charging member of the example shown in FIG. 1 may be manufactured as follows. In an example method, components of the materials for the conductive elastic body layer 2 are kneaded using a kneader to prepare materials for the conductive elastic body layer 2. The materials for the surface layer 3 are kneaded using a kneader such as a roll to obtain a mixture, and an organic solvent is added to this mixture, mixed and stirred, thereby preparing a coating liquid for the surface layer 3. A mold for injection molding, which is provided with a core (usually a shaft) serving as the conductive support 1 therein, is filled with the materials for the conductive elastic body layer 2 by injecting the materials, followed by heating and crosslinking under predetermined conditions. Remolding is performed to a base roll in which the conductive elastic body layer 2 is formed along the outer circumference surface of the conductive support 1. The coating liquid for the surface layer 3 is applied onto the outer circumference surface of the base roll to form the surface layer 3. In this way, a charging roller 10 in which the conductive elastic body layer 2 is formed on the outer circumference surface of the conductive support 1 and the surface layer 3 is formed on the outer circumference of the conductive elastic body layer 2 may be manufactured.

However, the method of forming the conductive elastic body layer 2 is not limited to injection molding, and casting, press molding, polishing, or a combination thereof may be employed. The method of applying the coating liquid for the surface layer 3 is not particularly limited, and dipping, spray coating, and roll coating may be employed.

### Electrophotographic Imaging Apparatus

A charging roller according to an example may be integrated into an electrophotographic cartridge or an electrophotographic imaging apparatus such as a printer, a copier, a scanner, a fax machine, or a multifunction peripheral incorporating two or more of these.

FIG. 3 is a cross-sectional view schematically illustrating an electrophotographic imaging apparatus and an electrophotographic cartridge including a charging roller according to an example.

Referring to FIG. 3, an electrophotographic imaging apparatus 31 may include an electrophotographic cartridge 30. The electrophotographic cartridge may include an electrophotographic photoconductor drum 11 that is charged by a charging roller 10 according to an example, which is a charging means disposed in contact with the electrophotographic photoconductor drum 11. The electrophotographic photoconductor drum 11 may be rotationally driven at a predetermined circumferential speed about an axis. The electrophotographic photoconductor drum 11 may be subjected to uniform charging of a positive or a negative predetermined potential on its surface by the charging roller 10 in the rotation process. The voltage applied to the charging roller 10 may be, for example, a DC voltage. However, if necessary, the voltage applied to the charging roller 10 may be, for example, a combination of an AC voltage and a DC voltage. In the electrophotographic imaging apparatus 31 according to an example, even when a DC voltage is applied to the charging roller 10, stable charging characteristics may be maintained for a longer period of time, and a high-quality output image may be obtained.

The charging roller 10 may charge the surface of the electrophotographic photoconductor drum 11 to a uniform potential value while rotating in contact with the electrophotographic photoconductor drum 11. The image portion is exposed by laser light to form an electrostatic latent image on the electrophotographic photoconductor drum 11. After the electrostatic latent image is made a visible image, for example, a toner image, by a developing unit 15, the toner image is transferred to an image receiving member 19 such as paper by a transfer roller 17 to which a voltage is applied. Toner remaining on a surface of the electrophotographic photoconductor drum 11 after the image transfer is cleaned by a cleaning unit, for example, a cleaning blade 21. The electrophotographic photoconductor drum 11 may be used again for image formation. The developing unit 15 includes a regulating blade 23, a developing roller 25, and a supply roller 27.

The electrophotographic cartridge 30 according to an example may integrally support the electrophotographic photoconductor drum 11, the charging roller 10, and the cleaning blade 21, may be attached to the electrophotographic imaging apparatus 31, and may be detached from the electrophotographic imaging apparatus 31. Another cartridge 29 may integrally support the developing unit 15 including the regulating blade 23, the developing roller 25, and the supply roller 27, and may be attached to the electrophotographic imaging apparatus 31, and may be detached from the electrophotographic imaging apparatus 31. Toner (not shown) may be located inside the developing unit 15.

### EXAMPLES

Hereinafter, various examples will be described. However, the scope of the disclosure is not limited thereto.

### Formation of Conductive Elastic Body Layer 2

An adhesive was applied to a cylindrical stainless-steel shaft having a diameter of 8 mm and a total length of 324 mm (the surface thereof was electroless plated with nickel) and was dried. This shaft was used as a support. 100 parts by weight of epichlorohydrin rubber (Manufacturer: Daiso Chemical Co., Ltd., product name: EPICHLOMER DG), 20 parts by weight of calcium carbonate, 2 parts by weight of carbon black (Manufacturer: Mitsubishi Chemical Corporation, product name: MA100) as a filler, 5 parts by weight of zinc oxide, and 2 parts by weight of tetrabutylammonium chloride as an ion-conducting agent were put into a hermetic mixer and kneaded for 20 minutes, and then 1.5 parts by weight of dibenzothiazyl disulfide as a vulcanization accelerator, 1.2 parts by weight of dipentamethylene thiuram tetrasulfide, and 1.0 part by weight of sulfur as a crosslinking agent were further added thereto and kneaded in an open roll for about 15 minutes to obtain a rubber composition. This rubber composition was extruded together with the shaft using a crosshead rubber extruder to be formed into a roller shape having an outer diameter of about 13 mm. Next, after a vulcanization process was performed in a vulcanization tube at about 160° C. for about 1.5 hours, both ends of the rubber were cut, the surface of the rubber was polished such that the outer diameter of the center portion of the roller became about 12 mm, and then the surface thereof was washed, dried and then irradiated with ultraviolet light to form a conductive elastic body layer 2. Thus, a conductive elastic body layer 2 having a thickness of about 4 mm and formed along the outer circumference surface of the shaft was obtained.

### Formation of Conductive Surface Layer 3

### Examples 1 to 8 and Comparative Examples 1 to 6

69.26 parts by weight of a polycaprolactone polyol (Manufacturer: Daicel Chemical Industries, product name: PCL320, hydroxyl value: 84 KOH mg/g), 51.24 parts by weight of isocyanate-type blocked HD (Manufacturer: Aekyung Chemical Co., Ltd., product name: D660, non-volatile matter 60%, NCO 6.5%, blocking agent: methyl ethyl ketone oxime), 1 part by weight of a polymer dispersant (Manufacturer: Lubrizol Co., Ltd., product name: SOLSPERSE™ 20000), 3 parts by weight of carbon black (Manufacturer: Mitsubishi Chemical Corporation, product name: MA100, specific surface area: 110 m²/g, pH 3.5), 2 parts by weight of hydrophobic fumed silica (Manufacturer: Evonik Resource Efficiency GmbH, trade name: AEROSIL R 974, specific surface area: 110 m²/g), and 0.1 parts by weight of silicone oil (Manufacturer: ShineEtsu Chemical Co., Ltd., product name: KF6002) were mixed with 200 parts by weight of a methyl isobutyl ketone (MIBK) solvent. Then, resin particles and inorganic particles whose added amounts are given in Tables 2 and 3 according to Examples and Comparative Examples were added as roughness forming particles, and were sufficiently stirred until the coating liquid became uniform to prepare a coating liquid for forming the surface layer 3.

The coating liquid for forming the surface layer was applied to the surface of the roller having the conductive elastic body layer 2 by a roll coating method, in this case, in order to obtain a desired layer thickness, coating was performed while scraping off unnecessary coating liquid with a scraper. The coated roller was air-dried for about 10 minutes and then dried at 160° C. for about 1 hour using an oven. Thus, a charging roller in which the surface layer 3 having a thickness of about 1.0 μm is laminated on the conductive elastic body layer 2 was obtained. Thus, a charging roller 10 including the shaft, which is the conductive support 1, the conductive elastic body layer 2 laminated along the outer circumference surface of the shaft, and the surface layer 3 laminated along the outer circumference surface of the conductive elastic body layer 2 was manufactured.

The types and properties of the resin particles or inorganic particles used in Examples 1 to 8 and Comparative Examples 1 to 6 are summarized in Table 1. The evaluation results of the charging rollers are summarized in Tables 2 and 3.

TABLE 1

| | | | Average | | Specific |
|---|---|---|---|---|---|
| | | | particle | CV | surface |
| Product | | | diameter | value | area |
| name | Manufacturer | Particle type | (μm) | (%) | (m²/g) |
| SSX-120 | Sekisui | Monodispersed | 20 | 10.39 | — |
| | Plastics | crosslinked | | | |
| | | PMMA resin | | | |
| SSX-127 | Sekisui | Monodispersed | 27 | 11.37 | — |
| | Plastics | crosslinked | | | |
| | | PMMA resin | | | |
| MBX-20 | Sekisui | Standard | 20 | 35.43 | — |
| | Plastics | dispersed | | | |
| | | crosslinked | | | |
| | | PMMA resin | | | |
| MBX-40 | Sekisui | Standard | 40 | 36.17 | — |
| | Plastics | dispersed | | | |
| | | crosslinked | | | |
| | | PMMA resin | | | |
| SSX-115 | Sekisui | Monodispersed | 15 | 10.45 | — |
| | Plastics | crosslinked | | | |
| | | PMMA resin | | | |
| NP-200 | AGC SI-Tech | Silica | 20 | — | 100 |
| NP-30 | AGC SI-Tech | Silica | 4 | — | 40 |
| NP-100 | AGC SI-Tech | Silica | 10 | — | 50 |
| MBX-5 | Sekisui | Crosslinked | 5 | — | — |
| | Plastics | PMMA resin | | | |

TABLE 2

| | | Ex*1 | Ex2 | Ex3 | Ex4 | Ex5 | Ex6 | Ex7 | Ex8 |
|---|---|---|---|---|---|---|---|---|---|
| First | SSX-120 | 10 | 10 | 10 | 10 | — | — | 15 | 7 |
| particle | (parts by weight) | | | | | | | | |
| | SSX-127 | — | — | — | — | 10 | — | — | — |
| | (parts by weight) | | | | | | | | |
| | MBX-20 | — | — | — | — | — | 10 | — | — |
| | (parts by weight) | | | | | | | | |
| | MBX-40 | — | — | — | — | — | — | — | — |
| | (parts by weight) | | | | | | | | |
| | SSX-115 | — | — | — | — | — | — | — | — |
| | (parts by weight) | | | | | | | | |
| | NP-200 | — | — | — | — | — | — | — | — |
| | (parts by weight) | | | | | | | | |
| Second | NP-30 | 10 | 3 | 30 | | 10 | 10 | 10 | 15 |
| particle | (parts by weight) | | | | | | | | |
| | NP-100 | — | — | — | 10 | — | — | — | — |
| | (parts by weight) | | | | | | | | |
| | MBX-5 | — | — | — | — | — | — | — | — |
| | (parts by weight) | | | | | | | | |
| M1/(M1 + M2) | | 0.50 | 0.77 | 0.25 | 0.50 | 0.50 | 0.50 | 0.60 | 0.32 |
| Inital | Microjitter | ⊚ | ⊚ | ⊚ | ⊚ | ⊚ | ◯ | ⊚ | ⊚ |
| image | Background | ⊚ | ⊚ | ⊚ | ⊚ | ⊚ | ◯ | ⊚ | ⊚ |
| | Image uniformity | ⊚ | ◯ | ⊚ | ⊚ | ⊚ | ⊚ | ⊚ | ⊚ |
| Image | Microjitter | ⊚ | ⊚ | ◯ | ⊚ | ⊚ | Δ | ⊚ | Δ |
| after | Background | ⊚ | ◯ | ◯ | ⊚ | ⊚ | Δ | ⊚ | Δ |
| printing | Image uniformity | ⊚ | Δ | ⊚ | Δ | ⊚ | ⊚ | ⊚ | ⊚ |
| 30,000 | | | | | | | | | |
| sheets | | | | | | | | | |
| of paper | | | | | | | | | |

*Ex: Example

TABLE 3

| | | CE*1 | CE2 | CE3 | CE4 | CE5 | CE6 |
|---|---|---|---|---|---|---|---|
| First | SSX-120 | — | — | 15 | — | 25 | — |
| particle | (parts by weight) | | | | | | |
| | SSX-127 | — | — | — | — | — | — |
| | (parts by weight) | | | | | | |
| | MBX-20 | 10 | — | — | — | — | — |
| | (parts by weight) | | | | | | |
| | MBX-40 | — | — | — | — | — | 10 |
| | (parts by weight) | | | | | | |
| | SSX-115 | — | 10 | — | — | — | — |
| | (parts by weight) | | | | | | |
| | NP-200 | — | — | — | 10 | — | — |
| | (parts by weight) | | | | | | |
| Second | NP-30 | — | 10 | — | — | 10 | — |
| particle | (parts by weight) | | | | | | |
| | NP-100 | — | — | — | — | — | 10 |
| | (parts by weight) | | | | | | |
| | MBX-5 | 10 | — | — | 10 | — | — |
| | (parts by weight) | | | | | | |
| M1/(M1 + M2) | | 0.50 | 0.50 | 1.00 | 0.50 | 0.71 | 0.50 |
| Initial | M/J | ◯ | X | ⊚ | X | Δ | X |
| image | B/G | ◯ | X | ⊚ | X | Δ | X |
| | Image uniformity | ◯ | ◯ | ◯ | X | ⊚ | X |
| Image | M/J | Δ | X | Δ | X | X | X |
| after | B/G | Δ | X | Δ | X | X | X |
| printing | Image uniformity | X | X | X | X | Δ | X |
| 30,000 | | | | | | | |
| sheets | | | | | | | |
| of paper | | | | | | | |

*CE: Comparative Example

### Image Evaluation

Image evaluations in the case of using the charging rollers obtained in Examples 1 to 8 and Comparative Examples 1 to 6 are performed as follows. After removing the charging roller from a commercially available laser printer (Manufacturer: HP, Model: HP JADE 3OPPM Color LaserJet A3), each of the charging rollers obtained in Examples 1 to 8 and Comparative Examples 1 to 6 was mounted thereon instead of the above charging roller. The printer was left for 8 hours under N/N (temperature 23° C. and relative humidity 55%) environmental conditions. Regarding the initial image obtained using this printer and the image after printing 30,000 sheets of paper, micro-jitter (M/J), background (B/G), and image uniformity were evaluated as follows. The results thereof are summarized in Tables 2 and 3. In this case, printing conditions were as follows.

Printing speed: typical speed 305 mm/sec;

Print paper type: Office Paper EC;

Applied bias: a DC voltage applied to the charging roller contacting the photoconductor is appropriately adjusted such that the photoconductor surface potential is −6000 V.

Evaluation of Micro-Jitter (M/J)

The electrophotographic image for micro-jitter evaluation was a half-tone image (medium-concentration image having horizontal stripes of width 1 dot and interval 2 dots in a direction perpendicular to the rotation direction of the photoconductor). This image was observed, and the presence or absence and/or degree of fine horizontal stripes (micro-jitter (M/J)) was evaluated according to the following criteria. However, in the case of initial image evaluation, after printing 20 sheets of paper under H/H conditions (temperature 32° C. and relative humidity 80%), one sheet of image having the worst image quality was evaluated.

⊚: Micro-jitter does not appear in the image at all;

∘: Micro-jitter appears slightly on a part of the image, but there is no practical problem;

Δ: Micro-jitter appears slightly at the front of the image, but this is within the usable range; and

×: Micro-jitter appears at the front of the image, thus causing practical problems.

### Evaluation of Background (B/G)

The electrophotographic image for background evaluation is a white image with a medium concentration (density). The whiteness of this output image was measured by “Reflectometer” (Manufacturer: Nippon Denshoku Ind. Ltd., Model Name: Microscopic Area Color Meter/Reflectometer VSR 400). Then, the background concentration (background density) (%) was calculated from a difference between whiteness of the output image and whiteness of the paper. The image background was evaluated according to the following criteria. In the case of initial image evaluation, after printing 20 sheets of paper under UL conditions (temperature 12° C. and relative humidity 10%), one sheet of image having the worst image quality was evaluated.

⊚: background density is less than 0.8% (optimally usable);

∘: background density is 0.8% or greater and less than 1.5% (usable);

Δ: background density is 1.5% or greater and less than 2.5% (in some cases, usable); and

×: background density is 2.5% or greater (not usable).

Evaluation of Image Uniformity

The electrophotographic image for image uniformity evaluation, similarly to electrophotographic image for micro-jitter evaluation, is a half-tone image (medium-density image having horizontal stripes of width 1 dot and interval 2 dots in a direction perpendicular to the rotation direction of the photoconductor). This image was observed, and image uniformity was evaluated according to the following criteria. In the case of initial image evaluation, after printing 20 sheets of paper under H/H conditions (temperature 32° C. and relative humidity 80%), one sheet of image having the worst image quality was evaluated.

⊚: image density unevenness (so called, image stains) does not exist;

∘: image density unevenness does not exist, but image has slight granularity;

Δ: image density unevenness slightly exists to such a degree of no practical problem; and

×: image density unevenness exists to impair image quality.

Referring to Tables 2 and 3, it may be found that an example imaging apparatus provided with the charging rollers of Examples 1 to 8 in which the kinds of first and second particles, the average particle diameter of first and second particles, the content of first particles, and the condition of M1/(M1+M2) are adjusted may stably generate high-quality images having no image defects such as background (B/G), micro-jitter (M/J), and image density unevenness. A reason for this may be that the charging rollers of Examples 1 to 8 may maintain stable charging characteristics even when they are used under all usable environments from low-temperature low-humidity environment atmosphere to high-temperature high-humidity environment atmosphere.

Although examples of the disclosure have been illustrated and described hereinabove, the disclosure is not limited thereto, and may be variously modified and altered by those skilled in the art to which the disclosure pertains without departing from the spirit and scope of the disclosure claimed in the claims. These modifications and alterations are to fall within the scope of the disclosure.

What is claimed is:

1. A charging member comprising:
a conductive support;
a conductive elastic body layer on the conductive support; and
a surface layer on the conductive elastic body layer,
wherein the surface layer includes a binder resin, first particles, and second particles, the first and second particles being dispersed in the binder resin, the first particles including acrylic resin particles having an average particle diameter of about 16 μm to about 35 μm, and the second particles including spherical silica particles having an average particle diameter of about 3 μm to about 10 μm,
wherein an amount of the first particles in the binder resin is in a range of about 5 parts by weight to about 20 parts by weight, based on 100 parts by weight of the binder resin, and
wherein, when a mass of the first particles is M1 and a mass of the second particles M2, the condition of 0.2≤M1/(M1+M2)≤0.8 is satisfied.

2. The charging member of claim 1, wherein the binder resin contains a urethane resin.

3. The charging member of claim 1, wherein the first particles have an average particle diameter of about 19 μm to about 28 μm.

4. The charging member of claim 1, wherein a coefficient of variation (CV value) of particle size distribution of the first particles, which is calculated by the equation below, is in a range of about 1% to about 15%:
CV value=(standard deviation/average particle diameter)×100(%).

5. The charging member of claim 1, wherein the second particles have a specific surface area of about 3 m²/g to about 50 m²/g.

6. The charging member of claim 1, wherein the acrylic resin particles include polymethyl methacrylate (PMMA) particles or polymethyl acrylate (PMAA) particles.

7. The charging member of claim 1, wherein the charging member is formed as a charging roller.

8. A cartridge for an electrophotographic imaging apparatus, the cartridge comprising:
an electrophotographic photoconductor;
a charging member contacting the electrophotographic photoconductor to charge the electrophotographic photoconductor;
a developing unit to develop an electrostatic latent image to a visible image; and
a cleaning unit to clean a surface of the electrophotographic photoconductor,
wherein the charging member comprises:
a conductive support;
a conductive elastic body layer on the conductive support; and
a surface layer on the conductive elastic body layer,
wherein the surface layer includes a binder resin, first particles, and second particles, the first and second particles being dispersed in the binder resin, the first particles including acrylic resin particles having an average particle diameter of about 16 μm to about 35 μm, and the second particles including spherical silica particles having an average particle diameter of about 3 μm to about 10 μm,
wherein an amount of the first particles in the binder resin is in a range of about 5 parts by weight to about 20 parts by weight, based on 100 parts by weight of the binder resin, and
wherein, when a mass of the first particles is M1 and a mass of the second particles M2, the condition of 0.2≤M1/(M1+M2)≤0.8 is satisfied.

9. The cartridge of claim 8, wherein the binder resin contains a urethane resin.

10. The cartridge of claim 8, wherein the first particles have an average particle diameter of about 19 μm to about 28 μm.

11. The cartridge of claim 8, wherein a coefficient of variation (CV value) of particle size distribution of the first particles, which is calculated by the equation below, is in a range of about 1% to about 15%:
CV value=(standard deviation/average particle diameter)×100(%).

12. The cartridge of claim 8, wherein the second particles have a specific surface area of about 3 m²/g to about 50 m²/g.

13. The cartridge of claim 8, wherein the acrylic resin particles include polymethyl methacrylate (PMMA) particles or polymethyl acrylate (PMAA) particles.

14. The cartridge of claim 8, wherein the charging member is formed as a charging roller.

15. An electrophotographic imaging apparatus comprising:
an electrophotographic photoconductor;
a charging member contacting the electrophotographic photoconductor to charge the electrophotographic photoconductor;
an exposure unit to form an electrostatic latent image on a surface of the electrophotographic photoconductor;
a developing unit to develop the electrostatic latent image to a visible image;
a transfer unit to transfer the visible image onto an image receiving member; and
a cleaning unit to clean a surface of the electrophotographic photoconductor,
wherein the charging member comprises:
a conductive support;
a conductive elastic body layer on the conductive support; and
a surface layer on the conductive elastic body layer,
wherein the surface layer includes a binder resin, first particles, and
second particles, the first and second particles being dispersed in the binder resin, the first particles including acrylic resin particles having an average particle diameter of about 16 μm to about 35 μm, and the second particles including spherical silica particles having an average particle diameter of about 3 μm to about 10 μm,
wherein an amount of the first particles in the binder resin is in a range of about 5 parts by weight to about 20 parts by weight, based on 100 parts by weight of the binder resin, and
wherein, when a mass of the first particles is M1 and a mass of the second particles M2, the condition of 0.2≤M1(M1+M223 0.8 is satisfied.
